(19) United States
(12) Patent Application Publication
(10) Pub. No.: US 2018/0300697 A1
(43) Pub. Date: Oct. 18, 2018

(54) EXCHANGE SYSTEM AND METHOD FOR POWER BANK

(71) Applicant: HSU HAN, Taipei City (TW)

(72) Inventor: HSU HAN, Taipei City (TW)

(21) Appl. No.: 15/489,740

(22) Filed: Apr. 18, 2017

(51) Int. Cl. G06Q 20/10; H02J 7/00; G06Q 30/06

(52) U.S. Cl. CPC G06Q 20/102; G06Q 30/0645; H02J 7/0045; H02J 7/0047

(57) ABSTRACT

An exchange method for a power bank enables a user to purchase the power bank in a full state by an identification component disposed on the power bank and a power exchange station and replace the depleted power bank with another power bank in a full state by recognizing the identification component with a recognition module at the power exchange station, obtaining a charging résumé of the power bank, and determining that the charging résumé complies with an exchange rule, so as to charge mobile electronic devices with the power bank. Therefore, with the exchange method, the power bank can be quickly charged to the full, and power bank users never need to wait for completion of a charging process.

### BACKGROUND OF THE INVENTION

### 1. Field of the Invention

The present invention relates to charging a power bank and, more particularly, to an exchange system and method for a power bank.

### 2. Description of the Prior Art

Depleted power banks put users on a search for public spaces where the power banks can be charged. However, public spaces of this sort are rare. As a result, the users must return to workplaces or go home in order to charge the power banks, and it is inconvenient to do so. For those users who manage to find a public space for charging power banks, their power banks will be in operation again only when fully charged or charged to a required power level. The lengthy charging process keeps the users waiting at the public space for hours, taking up their time and trimming down the reach of their feet. They hesitate to leave the charging process unattended for fear that the power banks being charged will be stolen. Last but not least, a premature end of the charging process always leaves the power banks inadequately charged, and in consequence the power banks run out of power soon, meeting urgent user needs at best.

### SUMMARY OF THE INVENTION

It is an objective of the present invention to provide an exchange system and method for a power bank, allowing users to charge the power bank to a full state quickly by a speedy charging process.

To achieve the above mentioned objective, an exchange method for a power bank of the present invention comprises the steps of: providing at least one power exchange station comprising at least one full power bank, wherein a power level of the at least one full power bank is a full state, and at least one identification component is fixedly disposed on the at least one full power bank each; providing a recognition module coupled to a database to recognize the at least one identification component of the at least one full power bank with the recognition module before accessing the database to fetch a charging résumé corresponding to the at least one full power bank, wherein the database is coupled to an application, wherein the charging résumé comprises a delivery data, a starting date, a charging count, and a charging state description corresponding to a last instance of charging, with the starting date adapted for use in calculating a warranty period, and the charging résumé adapted to be opened with the application so as to be read by a user; entering a personal account of the user of the full power bank with the application, following by sending the personal account to the database to create a usage record dedicated to the user; defining the at least one full power bank as a depleted power bank as soon as the power level of the at least one full power bank is reduced to a depleted state; taking the depleted power bank to the at least one power exchange station, scanning the at least one identification component with the recognition module, and fetching the charging résumé; and determining whether the charging résumé complies with an exchange rule, allowing the depleted power bank to be replaced by another full power bank at the at least one power exchange station when the determination is affirmative, wherein the exchange rule is defined as follows: the depleted power bank does not exhaust the warranty period, or the charging count does not exceed a specific range, and the charging state description displays a normal state.

Accordingly, the exchange method for a power bank enables a user to purchase the power bank with a full-state power level by the at least one identification component disposed on the power bank and the at least one power exchange station and replace the depleted power bank with another power bank with a full-state power level by recognizing the at least one identification component with the recognition module at the at least one power exchange station, obtaining the charging résumé of the power bank, and confirming that the charging résumé complies with the exchange rule, so as to charge mobile electronic devices with the power bank. Therefore, with the exchange method, the power bank can be quickly charged to the full, and power bank users never need to wait for completion of a charging process. Furthermore, given the exchange system of the present invention, related dealers may efficiently achieve cost control related to apparatus procurement, by conveniently providing related apparatuses, such as the charging unit and the recognition module, in related venues, such as convenience stores, thereby dispensing with the hassles of looking for additional venues, let alone carrying out destructive engineering projects, such as refurbishments and laying electrical cables, at related venues.

### BRIEF DESCRIPTION OF THE DRAWINGS

FIG. 1 is a schematic view of the process flow of an exchange method for a power bank according to the present invention;

FIG. 2 is a schematic view of the process flow of the exchange method, particularly regarding steps pertaining to a billing unit and a charging unit;

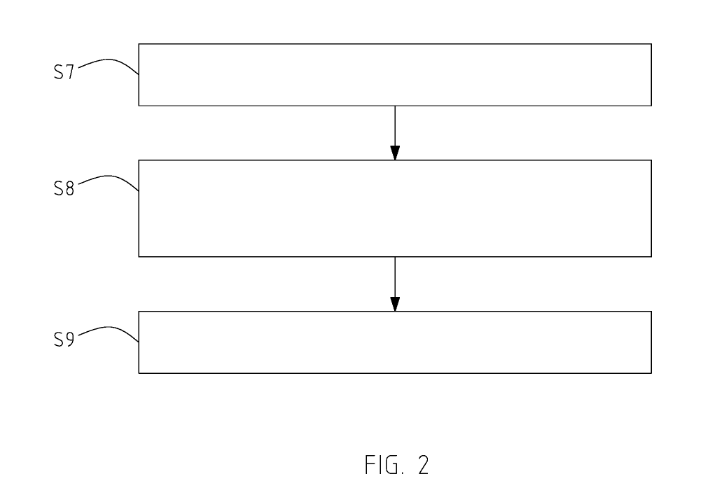

FIG. 3 is a function block diagram of an exchange system for a power bank according to the present invention;

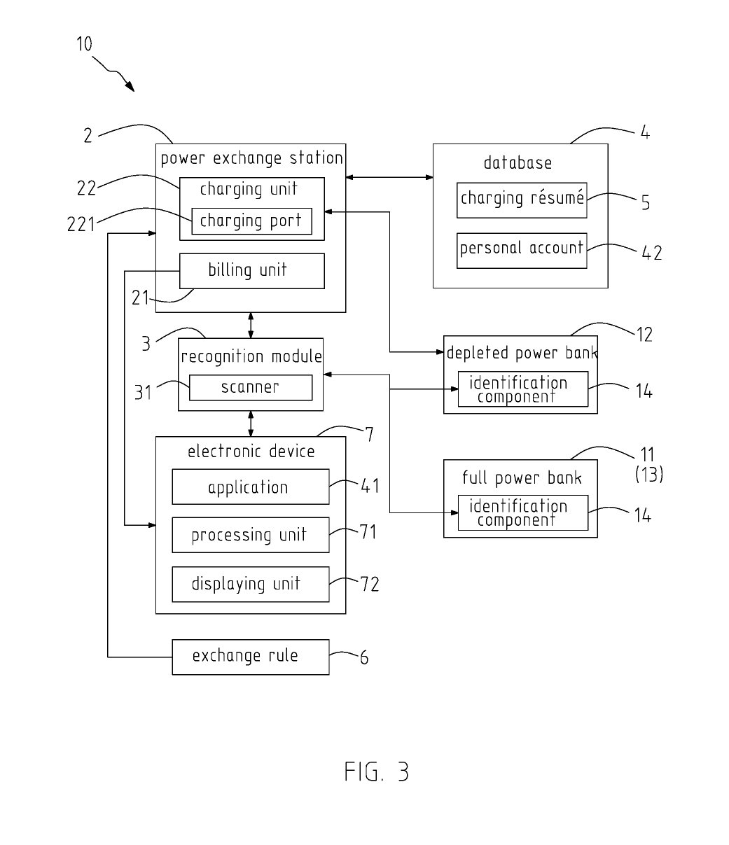

FIG. 4 is a function block diagram of a charging résumé according to the present invention; and

FIG. 5 is a schematic view of a depleted power bank or a full power bank according to the present invention.

### DETAILED DESCRIPTION OF THE EMBODIMENT OF THE INVENTION

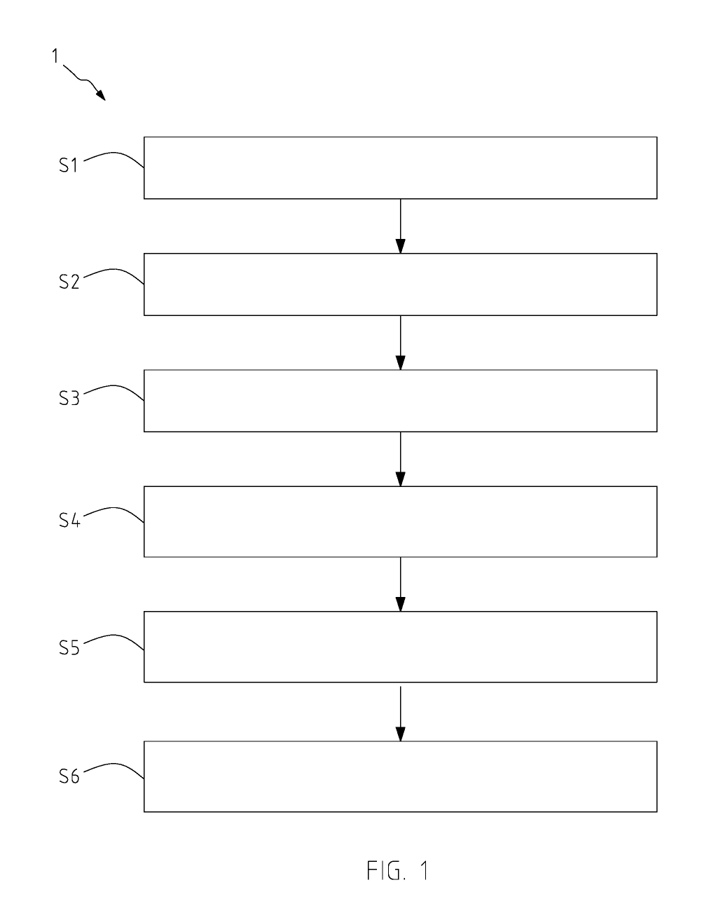

Referring to FIG. 1, the present invention provides an exchange method 1 for a power bank. The exchange method 1 comprises the steps described below. Step S1: providing at least one power exchange station 2 which comprises full power banks 11, 13, wherein the power level of the full power banks 11, 13 is a full state, and at least one identification component 14 is fixedly disposed on the full power banks 11, 13 each. The full state is defined as at least 80% of the maximum charging level configured upon delivery of the full power bank 11. For example, given a factory maximum charging level of 10000 mAh, the full state is defined as a power level of 8000 mAh. The at least one power exchange station 2 may be based in a city or located at any venue, provided that it is accessible to the general public. Examples of the venue include convenience stores, hypermarkets, and government agency office buildings. This preferred embodiment is exemplified by a convenience store.

Step S2: providing a recognition module 3 coupled to a database 4 to recognize the at least one identification component 14 of the full power bank 11 with the recognition module 3 before accessing the database 4 to fetch a charging résumé 5 corresponding to the full power bank 11, wherein the database 4 is coupled to an application (App) 41. Specifically speaking, the database 4 is a cloud database connected to a terminal apparatus through the Internet by wired or wireless transmission. The at least one identification component 14 is a quick response code (QR code), a two-dimensional barcode, or any other component to be sensed, scanned, or recognized. This embodiment is exemplified by a QR code. The at least one identification component 14 is formed on the surface of the full power bank 11 by laser marking or printing. Once the at least one identification component 14 is damaged, the charging résumé 5 cannot be fetched. The at least one identification component 14 is fixedly disposed on rather than simply adhered to the full power bank 11; hence, the at least one identification component 14 is prevented from being maliciously removed from the full power bank 11 and adhered to another power bank in an attempt to commit identity theft. Each identification component 14 corresponds to one and only one power bank.

The recognition module 3 comprises a scanner 31 electrically connected to an electronic device 7, 70. The scanner 31 scans and recognizes the at least one identification component 14. The electronic device 7, 70 comprises a processing unit 71 and a displaying unit 72. The displaying unit 72 displays an operating interface for the application 41 and the charging résumé 5. After scanning the at least one identification component 14, a user connects the electronic device 7, 70 to an installation frame through a network and then installs the application 41 on the electronic device 7, 70. In a preferred embodiment, the electronic device 70 is a mobile phone held by the user, whereas the scanner 31 is a built-in camera on the mobile phone. In another preferred embodiment, the electronic device 7, which the scanner 31 is integrated into, is disposed in the at least one power exchange station 2 and thus conveniently operated by workers of the at least one power exchange station 2. The workers of the at least one power exchange station 2 operate the electronic device 7, whereas the user operates the electronic device 70, such as a mobile phone.

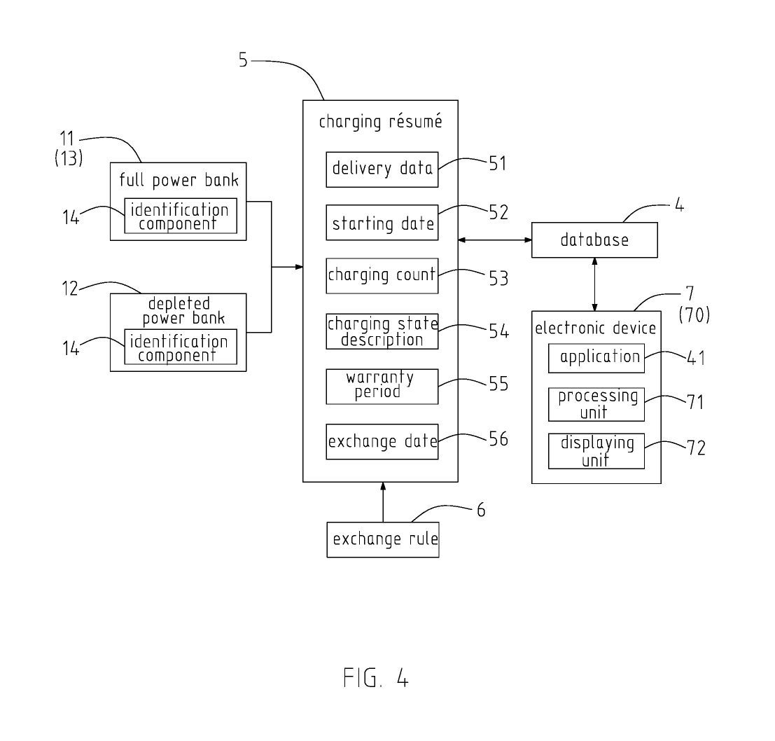

The charging résumé 5 comprises a delivery data 51, a starting date 52, a charging count 53, and a charging state description 54 corresponding to the last instance of charging (as shown in FIG. 4). The charging résumé 5 can be opened with the application 41, so as to be read by the user. The delivery data 51 comprises the maximum charging level, country of manufacture, and date of manufacture of the full power banks 11, 13 to inform the user of the particulars of the power banks 11, 13. The starting date 52 is for use in calculating a warranty period 55. The warranty period 55 is set to two years. The charging count 53 calculates a cumulative total of instances of charging performed at the at least one power exchange station 2. The cumulative total calculated by the charging count 53 does not include any instance of charging performed by the user at any apparatus other than the at least one power exchange station 2. The charging state description 54 is depicted by a curve illustrative of the state of the charging process. In general, a normal charging curve is defined as a charging curve located within 20% of a standard curve. According to the present invention, the charging résumé 5 is preconfigured to illustrate the last charging state by the charging state description 54, and the user reads the charging state description 54 of each instance of charging by the application 41. The charging résumé 5 further comprises an exchange date 56 on which the full power bank 11 was exchanged, allowing the user to gain insight to the course of the use of the full power bank 11.

Step S3: entering a personal account 42 of the user of the full power bank 11 with the application 41 of the electronic device 7 in the at least one power exchange station 2, following by sending the personal account 42 to the database 4 to create a usage record dedicated to the user. The personal account 42 of the user comprises the user's mobile phone number.

According to the present invention, the exchange method 1 for a power bank embodies a sort of commercial behavior based on the user-pays principle or a sort of nonprofit service provided free of charge. In this preferred embodiment, the exchange method 1 of the present invention relates to commercial behavior based on the user-pays principle. Specifically speaking, the full power bank 11 is leased or purchased by an installment plan. It is cheap to lease the full power bank 11, but the user has to return the full power bank 11 upon expiry of the lease. The installment plant is pricey, but the user is in possession of the full power bank 11 and thus need not return the full power bank 11. After the recognition module 3 has recognized the at least one identification component 14, the starting date 52 of the full power bank 11 purchased is generated, sent automatically to the database 4, and stored therein.

Step S4: defining the full power bank 11 as a depleted power bank 12 as soon as the power level of the full power bank 11 is reduced to a depleted state. As mentioned before, after paying for the full power bank 11, the user begins using the full power bank 11 to charge a mobile phone. As soon as the power level of the full power bank 11 is reduced to a depleted state, the full power bank 11 is defined as the depleted power bank 12. The depleted state means that the full power bank 11 is going to run out of power and thus its power level is much lower than the full state. In this preferred embodiment, the depleted state is defined as being less than 20% of the remaining power level or having run of power, but the present invention is not limited thereto.

Step S5: taking the depleted power bank 12 to the at least one power exchange station 2 in the vicinity of the user, scanning the at least one identification component 14 with the recognition module 3, and fetching the charging résumé 5.

Step S6: determining whether the charging résumé 5 of the depleted power bank 12 complies with an exchange rule 6, allowing the depleted power bank 12 to be replaced by another full power bank 13 at the at least one power exchange station 2 when the determination is affirmative, wherein, after the charging résumé 5 has been scanned, the processing unit 71 of the electronic device 7 of the at least one power exchange station 2 automatically performs the act of determining whether the charging résumé 5 complies with the exchange rule 6 and sends to the application 41 a message related to compliance with the exchange rule 6. The exchange rule 6 is defined as follows: the depleted power bank 12 does not exhaust the warranty period 55, or the charging count 53 does not exceed a specific range, and the charging state description 54 displays a normal state. Hence, with the warranty period 55 not having been exhausted and the charging state description 54 being normal, the user may change power banks at the at least one power exchange station 2 unlimited times. According to the present invention, the exchange method 1 for a power bank allows for an annual charging count of 500 when dealing with a user who charges power banks infrequently. Every visit paid by the infrequent user to the at least one power exchange station 2 with a view to replacing the depleted power bank 12 with the other full power bank 13 counts toward the annual charging count; hence, the replacement of the depleted power bank 12 will be permitted, provided that the charging count has not reached its specific limit. When the charging count 53 displayed on the charging résumé 5 is zero, it means that the depleted power bank 12 related to the charging résumé 5 has never been changed at the at least one power exchange station 2. As mentioned before, the exchange method 1 of the present invention enables the user to replace, at the at least one power exchange station 2, the depleted power bank 12 with the full power bank 13 whose power level is a full state.

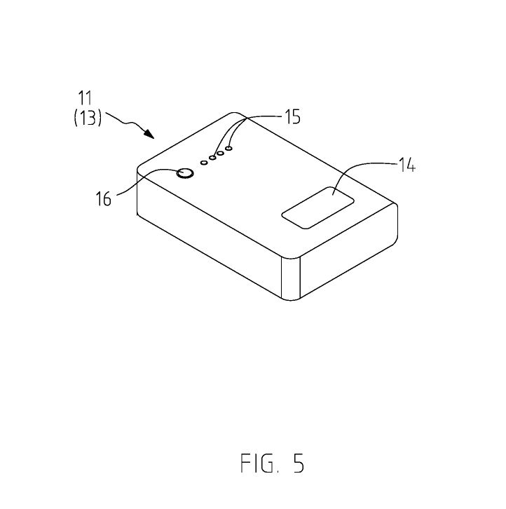

Step S7: recognizing, before replacement of the depleted power bank 12 by the other full power bank 13 and to protect the user's rights and interests, the at least one identification component 14 of the other full power bank 13 by the recognition module 3 of the electronic device 70 of the user, fetching the charging résumé 5, determining whether the charging résumé 5 of the depleted power bank 12 complies with the exchange rule 6, and entering or getting connected to the personal account 42 with the application 41 when the determination is affirmative, so as to update the user's usage record. Hence, every instance of replacement is recorded in the personal account 42 and automatically recorded on the charging résumé 5 for the user's reference. In another preferred embodiment, indicators 15 (shown in FIG. 5) and a key 16 are disposed on the full power banks 11, 13. The user may press the key 16 to make the indicators 15 display a power level state. The full state is indicated when all the indicators 15 display a green color. The depleted state is indicated when none of the indicators 15 displays a color or only one of the indicators 15 turns on. Hence, the user gains insight into a power level state with the indicators 15.

Step S8: producing a bill by a billing unit 21. The at least one power exchange station 2 further comprises the billing unit 21 coupled to the database 4. When the charging résumé 5 of the other full power bank 13 and the depleted power bank 12 complies with the exchange rule 6, the billing unit 21 produces a bill adapted to describe a replacement-related fee payable by the user and recorded in the user's usage record. Specifically speaking, the bill can be replaced with a payment request slip printed out by the billing unit 21 and intended for use by the user to pay the replacement-related fee. Alternatively, the user pays the replacement-related fee by debiting the user's bank account.

Step S9: generating the charging state description 54 and the charging count 53 by a charging unit 22, and defining the depleted power bank 12 as the full power bank 13. The at least one power exchange station 2 further comprises the charging unit 22 coupled to the database 4, The charging unit 22 comprises charging ports 221. The charging ports 221 each have a charging gate (not shown). Upon completion of replacement of the depleted power bank 12 by the full power bank 13, a worker of the at least one power exchange station 2 opens the charging gate, connects the depleted power bank 12 to a corresponding one of the charging ports 221, and starts a charging process. During the charging process, the charging unit 22 generates the charging state description 54 and the charging count 53, which are then automatically sent to the database 4. As soon as the depleted power bank 12 is charged to acquire a full-state power level, the depleted power bank 12 is defined as the full power bank 13 for use by any other user to replace his or her depleted power bank later.

With reference to the exchange method 1, the present invention provides an exchange system 10 for a power bank. Referring to FIG. 4, there is shown a function block diagram of a charging résumé according to the present invention. The exchange system 10 comprises at least one power exchange station 2 which comprises full power banks 11, 13. The full power banks 11, 13 each have a power level in the full state. The at least one identification component 14 is fixedly disposed on the full power banks 11, 13. After the power level of the full power bank 11 has been reduced to a depleted state, the full power bank 11 is defined as a depleted power bank 12. The recognition module 3 is coupled to the database 4 and comprises a scanner 31. The recognition module 3 recognizes the at least one identification component 14 of the full power bank 11, accesses the database 4, and fetches the charging résumé 5 corresponding to the full power bank 11. An application 41 is coupled to the database 4. The application 41 opens the charging résumé 5 so that the charging résumé 5 can be read by the user. The personal account 42 of the user of the full power bank 11 is entered with the application 41 or connected to the application 41 and sent to the database 4 to create a usage record dedicated to the user. The charging unit 22 is disposed at the at least one power exchange station 2. The charging unit 22 is coupled to the database 4 and comprises charging ports 221. The way of operating the exchange system 10 is already described before and thus is not described again hereunder.

According to the present invention, the exchange method 1 for a power bank enables a user to purchase the power bank with a full-state power level by the at least one identification component 14 disposed on the power bank and the at least one power exchange station 2 and replace the depleted power bank with another power bank with a full-state power level by recognizing the at least one identification component 14 with the recognition module 3 at the at least one power exchange station 2, obtaining the charging résumé 5 of the power bank, and confirming that the charging résumé 5 complies with the exchange rule 6, so as to charge mobile electronic devices with the power bank. Therefore, with the exchange method 1, the power bank can be quickly charged to the full, and power bank users never need to wait for completion of a charging process. Furthermore, given the exchange system 10 of the present invention, related dealers may efficiently achieve cost control related to apparatus procurement, by conveniently providing related apparatuses, such as the charging unit 22 and the recognition module 3, in related venues, such as convenience stores, thereby dispensing with the hassles of looking for additional venues, let alone carrying out destructive engineering projects, such as refurbishments and laying electrical cables, at related venues.

It is understood that the invention may be embodied in other forms within the scope of the claims. Thus the present examples and embodiments are to be considered in all respects as illustrative, and not restrictive, of the invention defined by the claims.

What is claimed is:

1. An exchange method for a power bank, comprising the steps of:
providing at least one power exchange station comprising at least one full power bank, wherein a power level of the at least one full power bank is a full state, and at least one identification component is fixedly disposed on the at least one full power bank each;
providing a recognition module coupled to a database to recognize the at least one identification component of the at least one full power bank with the recognition module before accessing the database to fetch a charging résumé corresponding to the at least one full power bank, wherein the database is coupled to an application,
wherein the charging résumé comprises a delivery data, a starting date, a charging count, and a charging state description corresponding to a last instance of charging, with the starting date adapted for use in calculating a warranty period, and the charging résumé adapted to be opened with the application so as to be read by a user;
entering a personal account of the user of the full power bank with the application, following by sending the personal account to the database to create a usage record dedicated to the user;
defining the at least one full power bank as a depleted power bank as soon as the power level of the at least one full power bank is reduced to a depleted state;
taking the depleted power bank to the at least one power exchange station, scanning the at least one identification component with the recognition module, and fetching the charging résumé; and
determining whether the charging résumé complies with an exchange rule, allowing the depleted power bank to be replaced by another full power bank at the at least one power exchange station when the determination is affirmative,
wherein the exchange rule is defined as follows: the depleted power bank does not exhaust the warranty period, or the charging count does not exceed a specific range, and the charging state description displays a normal state.

2. The exchange method of claim 1, wherein, before replacement of the depleted power bank by the other full power bank, the at least one identification component of the other full power bank is recognized by the recognition module, and the charging résumé is fetched, so as to determine whether the charging résumé complies with the exchange rule and enter the personal account with the application when the determination is affirmative, thereby updating the user's usage record.

3. The exchange method of claim 2, wherein the at least one power exchange station further comprises a billing unit coupled to the database so that the billing unit produces a bill when the charging résumé complies with the exchange rule, and the bill is adapted to describe a replacement-related fee payable by the user and recorded in the user's usage record.

4. The exchange method of claim 1, wherein the full power bank is leased or purchased by an installment plan, and the starting date of the full power bank purchased is generated upon recognition of the at least one identification component by the recognition module, sent automatically to the database, and stored therein.

5. The exchange method of claim 4, wherein, if the charging count displayed on the charging résumé is zero, the depleted power bank related to the charging résumé has never been changed at the at least one power exchange station.

6. The exchange method of claim 1, wherein the at least one power exchange station further comprises a charging unit coupled to the database and comprising charging ports, and, upon completion of replacement of the depleted power bank by the full power bank, the depleted power bank gets connected to one of the charging ports and starts to undergo a charging process during which the charging unit generates the charging state description and the charging count, which are then automatically sent to the database, and the depleted power bank is defined as the full power bank as soon as the depleted power bank is charged to acquire a full-state power level.

7. The exchange method of claim 1, wherein the at least one identification component is one of a quick response code and a two-dimensional barcode and is fixedly disposed on a surface of the full power bank.

8. The exchange method of claim 1, wherein the personal account of the user comprises a mobile phone number of the user, and the full power bank charges a mobile phone.

9. The exchange method of claim 1, wherein the recognition module comprises a scanner electrically connected to at least one electronic device and adapted to scan and recognize the at least one identification component, the at least one electronic device each comprising a processing unit and a displaying unit, the processing unit determining whether the charging résumé complies with the exchange rule, and the displaying unit displaying an operating interface for the application and the charging résumé.

10. An exchange system for a power bank, comprising:
at least one power exchange station comprising full power banks each having a power level in a full state, with at least one identification component fixedly disposed on the full power banks, wherein one of the full power banks is defined as a depleted power bank after the power level of the full power bank has been reduced to a depleted state;
a recognition module coupled to a database and adapted to recognize the at least one identification component of the full power bank, access the database, and fetch a charging résumé corresponding to the full power bank, wherein the charging résumé comprises a delivery data, a starting date, a charging count, and a charging state description corresponding to a last instance of charging, with the starting date adapted for use in calculating a warranty period;
an application coupled to the database and adapted to open the charging résumé to be read by a user, wherein a personal account of the user of the full power bank is entered with the application and sent to the database to create a usage record dedicated to the user; and
a charging unit disposed at the at least one power exchange station, coupled to the database, and comprising charging ports,
wherein, upon determination that the charging résumé of the depleted power bank complies with an exchange rule, the depleted power bank is replaced with another full power bank at the at least one power exchange station, and, upon completion of replacement of the depleted power bank by the full power bank, the depleted power bank gets connected to one of the charging ports and starts to undergo a charging process during which the charging unit generates the charging state description and the charging count, which are then automatically sent to the database, and the depleted power bank is defined as the full power bank as soon as the depleted power bank is charged to acquire a full-state power level.
